(19) United States
(12) Patent Application Publication
(10) Pub. No.: US 2021/0253174 A1
(43) Pub. Date: Aug. 19, 2021

(54) MOTOR VEHICLE CHASSIS PROVIDED WITH A COMPONENT WHICH IS ANTAGONISTICALLY SUPPORTED AGAINST A CROSSMEMBER AND A SIDE MEMBER IN THE EVENT OF LATERAL IMPACT

(71) Applicant: PSA AUTOMOBILES SA, Poissy (FR)

(72) Inventors: Tou THOR, PONT DE ROIDE VERMONDANS (FR); Stéphane FONFREDE, BELFORT (FR)

(21) Appl. No.: 16/972,975

(22) PCT Filed: May 17, 2019
(86) PCT No.: PCT/FR2019/051130

§ 371 Date: Dec. 7, 2020

(30) Foreign Application Priority Data
Jun. 19, 2018 (FR) 1855377

(51) Int. Cl. B62D 21/15; B62D 25/20

(52) U.S. Cl. CPC B62D 21/157; B62D 25/2036

(57) ABSTRACT

The invention relates to a motor vehicle chassis (3) comprising lateral side members (4), at least one of which is connected to at least one longitudinal frame element (5) via a crossmember (6), a first end (6a) of which is fixed to one of said lateral side members (4) and a second end (6b) of which is fixed to said longitudinal frame element (5). A part (7) jointly attached to the lateral side member (4) and to the crossmember (6) is provided with a support member (10) which is transversely (T1) interposed on the chassis (3) between a wall (4a) of the side member (4) and an end face (6c) of the first end (6a) of the crossmember (6), against which said support member (10) is antagonistically supported in a transverse manner (T1) under the effect of a lateral impact (C1) applied against the side member (4).

### CROSS-REFERENCE TO RELATED APPLICATIONS

This application is the US National Stage under 35 USC § 371 of International Application No. PCT/FR2019/051130, filed 17 May 2019 which claims priority to French Application No. 1855377 filed 19 Jun. 2018, both of which are incorporated herein by reference.

### BACKGROUND

The present invention relates to the field of motor vehicle chassis, and more particularly to the modalities of the deformation thereof under the effect of a lateral impact to which such a chassis is potentially subjected. The invention relates more specifically to an arrangement of the junction between a crossmember and a side member constituting of the chassis, participating in the deformation of the crossmember under the effect of a lateral impact applied against the side member.

Motor vehicles conventionally comprise a chassis which forms an underbody frame of the vehicle, and which is comprised of longitudinal frame elements, such as side members, which are braced by transverse frame elements, notably crossmembers. More particularly, the chassis comprises lateral side members bordering the right and left sides of the chassis, respectively, and which are braced by crossmembers. A floor, formed by a fairing, for example, is installed under the underbody frame, and is fixed at least to the side members and to the crossmembers.

At least one additional longitudinal frame element, such as a side member or a tube, can also be interposed at a transverse distance between two longitudinal frame elements, in particular the lateral side members. Such a longitudinal frame element is then potentially connected to at least one of the lateral side members via at least one crossmember, such as, in particular, at least one seat crossmember supporting at least one seat for the passengers of the vehicle.

In this context, the chassis includes arrangements to protect the passengers in the event of an impact to which the vehicle is subjected. Such arrangements are essentially aimed at controlling the modalities of deformation of the frame elements constituting the chassis.

In the context of the invention, a deformation of the crossmembers is more specifically considered in the event of a lateral impact borne by the chassis, in particular when the vehicle suffers an accident against an obstacle to its progression which strikes one of the lateral side members at its junction zone with a crossmember.

The impact then generates a thrust force against the end of the crossmember fixed to the lateral side member, which tends to deform the crossmember by compressing and/or bending the cross-member. It is known to provide the junction end of the crossmember with the lateral side member with a means promoting a compressive deformation of the crossmember in order to absorb the energy developed by the impact, as disclosed, for example, in FR 3024422 (PEUGEOT CITROEN AUTOMOBILES).

### SUMMARY

In this context, the present invention relates to a motor vehicle chassis comprising longitudinal frame elements, including side members, and at least one crossmember connecting any one of the lateral side members to a longitudinal frame member of the chassis.

The objective of the invention is to improve the safety of the vehicle in the event of a lateral impact applied against the chassis, in particular in a junction zone between a lateral side member and a crossmember, by limiting deformation of the chassis as a result of the application of the impact. It is more specifically aimed at limiting:
a risk of intrusion of the crossmember toward the passenger compartment of the vehicle as a result of its deformation, under the effect of a thrust force borne by the crossmember and generated by the lateral impact, and/or
a consequent deformation of an attached longitudinal frame element that the chassis is likely to include by being transversely interposed between the lateral side members, to at least one of which lateral side members the attached longitudinal frame element is able to be connected by at least one crossmember.

Another object of the invention is to achieve the objective sought by taking into account the constraints liable to render a potential solution unacceptable. Such constraints in particular include:
a limitation of the cost of purchasing the vehicle in the context of notoriously severe economic competition in the automotive sector. In particular, a solution is targeted which is structurally simple and/or which avoids complicating the methods of mounting on the chassis the members the chassis uses, and/or
a limitation of the mass of the vehicle.

By way of non-restrictive indication for assessing the invention and/or the technical results obtained, a lateral impact of moderate amplitude applied against the chassis is taken into consideration, the impact applied locally in an orientation with respect to the longitudinal direction of the chassis included in an angular margin of approximately 10°. In particular indicated on the one hand is a relative orientation between the longitudinal direction in which the chassis extends and the direction in which the impact is applied against the chassis of between approximately 70° and 80°, and on the other hand an amplitude of the lateral impact considered for a vehicle progress of between approximately 30 km/h (˜19 mph) and 35 km/h (˜22 mph).

If necessary, certain relative concepts and/or terms which are commonly accepted in the automotive field to describe a vehicle, as well as the body that it comprises and/or its components, are specified.

The directions in which a vehicle extends are commonly defined in an orthonormal coordinate system identified in a longitudinal direction, a transverse direction and a vertical direction. Such directions and the related relative concepts are subsequently applied to the chassis and/or its components with regard to their own structure and/or their relative positions, unless otherwise specified.

The terms “side member” or “tube” designate longitudinal frame elements of the chassis. A tube and/or a side member may be placed transversely between two lateral side members, to at least one of which lateral side members the tube is connected by a crossmember. The concept lateral when qualifying side members is considered with regard to the right and/or left longitudinal sides of the chassis with respect to the position of the driver of the vehicle in the driving station. The term “crossmember” means a transverse frame element of the chassis interposed along its main extension between two longitudinal frame elements. The ends of a crossmember are therefore considered relative to each other along the main extension of the crossmember. An end face of a crossmember is formed at one end thereof while being concurrent with the main direction in which the crossmember extends.

The concepts “lower” and “upper,” or other related concepts such as “under” and/or “below,” “on” and/or “above,” and “base” and/or “top,” or “overhang,” for example, are relative concepts considered with regard to the concept of verticality in relation to the rolling plane of the vehicle which identifies the direction in which the chassis extends in elevation.

The concepts, terms and details which have just been provided are therefore used to define the invention which will be understood in the field of the invention without necessarily having to specify them again.

The above objectives are achieved by applying the following provisions.

A motor vehicle chassis comprises side members, at least one of which is connected to at least one longitudinal frame element via a crossmember. A first end of the crossmember is fixed to the lateral side member and a second end of the crossmember is attached to the longitudinal frame element.

In this context, the chassis is distinctive in that a part that is jointly fixed to the lateral side member and to the crossmember is provided with a support member which is transversely interposed on the chassis between a wall of the side member and an end face of the first end of the crossmember. The support member is antagonistically supported in a transverse manner against the wall of the side member and the end face of the first end of the crossmember, under the effect of a lateral impact applied against the side member.

It is in particular taken into consideration that the thrust force generated by the impact is likely to be oriented diversely in Euclidean space, by developing force components of specific amplitudes along the respective directions in which the chassis extends. In this context, the part is configured as a force deflector which makes it possible, via the support member, to optimize the amplitude of a transverse force component transmitted to the crossmember by the side member and resulting from the thrust force generated by the lateral impact applied against the side member.

This has the result of controlling a deformation of the crossmember under the effect of the lateral impact, by limiting its bending and by optimizing its compressive deformation along the main direction in which it extends, toward the longitudinal frame element to which the crossmember is fixed via the second end thereof. Deformation of the crossmember in bending and/or random deformation of the longitudinal frame element are thus limited, or even avoided, depending on the amplitude and/or orientation of the lateral impact applied against the side member.

It emerges from this that the deformation of the chassis which results therefrom occurs essentially in the general extension plane of the underbody of the vehicle comprising the frame elements, while being controlled at least via the part. This finally has the advantage of securing the passenger compartment and therefore of preserving the passengers sitting on a seat potentially supported by the crossmember, in the event of a lateral impact applied against a lateral side member in the environment close to its junction with the crossmember.

The wall of the side member is in particular provided by a wing extending vertically and longitudinally which the side member comprises at the lower end thereof oriented toward the bottom of the chassis, or in other words toward the rolling plane of the vehicle. As previously referred to, the concepts of “lower” and “bottom” are understood with regard to the vertical extension in elevation of the chassis.

According to one embodiment, the part extends transversely over the chassis in successive overlap under the first end of the crossmember and under the side member. As previously referred to, the concept of “under” is understood with regard to the vertical extension in elevation of the chassis.

Such a position of the part on the chassis makes it possible to optimize the compressive stressing of the crossmember and to limit its bending in its main direction of extension. This also makes it possible to simplify the structure of the part without affecting its performance, to simplify the methods for mounting it on the chassis and/or to reinforce a robust junction of the part to the crossmember and to the lateral side member.

Thus according to one embodiment, the part is advantageously arranged in a plate which extends at least under the first end of the crossmember and which is provided with the support member. The support member is provided transversely projecting from the crossmember between the end face of its first end and the wall of the side member. It is understood here that the plate extends in a plane oriented in the longitudinal direction and the transverse direction in which the chassis extends.

Thus again according to one embodiment, the support member is advantageously formed by at least one lug integrated into the plate and extending in elevation overhanging the plane in which the plate extends. It is understood here that the lug extends over the chassis transversely and longitudinally along the plane of the plate, and in elevation toward the side member relative to the plane of the plate.

According to one embodiment, the part incorporates at least one member for controlling its deformation favoring its folding against the end face of the crossmember subjected to compression in the event of a lateral impact. Such folding by tilting of the part makes it possible to optimize the orientation of the thrust force essentially along the transverse force component applied against the end face of the crossmember in its main direction of extension.

Such a control member is for example formed by:
at least one boss formed on the plate extending along the transverse extension of the chassis, the vertical extension of which is progressively reduced from its end fixed to the wall of the side member,
at least one weakening member of the at least one boss favoring the compression thereof under the effect of the impact, for example formed by a relief and/or a groove oriented perpendicular to the main direction in which the boss extends (i.e., along the longitudinal extension of the chassis), and/or
at least one member for weakening the plate, for example formed by at least one opening through its thickness.

Thus according to one embodiment, the part has, projecting from its underside, at least one boss extending transversely with respect to the chassis. The extension of the boss in elevation gradually decreases from the support member following the extension of the boss transversely relative to the chassis.

The boss reinforces the robustness of the part and its resistance to deformation in the initial phase of application of the lateral impact against the side member, so as to ultimately initiate obtaining an increase in the amplitude of the transverse thrust component against the end face of the crossmember. The reduction of the boss in elevation then makes it possible to increase the control of the deformation of the part by folding against the end face of the crossmember, as a result of its vertical tilting under the effect of the impact.

Thus again according to one embodiment, the boss comprises at least one recessed relief formed on the underside of the part extending perpendicularly to the main extension of the boss following the longitudinal extension of the chassis.

The at least one relief promotes compression of the boss transversely on the chassis during the deformation of the part and the compression of the crossmember under the effect of the lateral impact. The compression of the boss promotes compression of the plate and therefore promotes control of maintaining the optimized amplitude of the transverse thrust component against the crossmember. It should be noted that the crossmember preferably comprises weakening reliefs promoting its compression, such as, for example, grooves formed at the base of the crossmember and oriented longitudinally relative to the chassis.

Thus again according to one embodiment, the plate has an opening formed through it along its thickness, or in other words passing through the plate perpendicular to the plane in which the plate extends. The deformation by folding of the part against the end face of the crossmember is promoted as a result.

According to one embodiment, the part is fixed under a floor fitted to the chassis. The floor is interposed between the part on the one hand and the side member and the first end of the crossmember on the other hand.

It should be noted that the results obtained by the chassis including the part are most efficient in the case where the crossmember is interposed between the lateral side member and one the longitudinal frame element transversely interposed between the lateral side members of the chassis. The extension of the crossmember between its ends being limited, the control of its deformation by applying the methods provided for by the invention is improved.

Thus according to one preferred embodiment, the longitudinal frame element is either a side member or a tube that is transversely interposed on the chassis between the lateral side members.

The subject of the invention is also a motor vehicle equipped with a chassis according to the invention.

### DESCRIPTION OF THE FIGURES

One embodiment of the chassis will be described in relation to the accompanying sets of figures, in which:

FIG. 1 is an illustration showing, by way of non-limiting indication, a context of a lateral impact caused against a chassis of a motor vehicle, in which context the improved chassis is particularly intended to be applied.

FIG. 2 is composed of several diagrams (a), (b) and (c) illustrating the conventional deformation methods of the chassis in the context shown in FIG. 1, it being understood that the improved chassis is excluded in the diagrams of this FIG. 2.

FIG. 3 is made up of several diagrams (d), (e) and (f) illustrating one embodiment of the improved chassis in relation to the diagrams of FIG. 1.

FIGS. 4 and 5 are perspective views from above and below, respectively, of an embodiment of a part fitted to the chassis.

### DETAILED DESCRIPTION

The figures and the detailed descriptions thereof disclose the invention according to particular modalities which are not restrictive as regards the scope of the invention as defined by the claims. The figures and their detailed descriptions of one embodiment of the chassis can serve to better define it, if necessary in relation to the general description which has just been given.

In FIG. 1, a motor vehicle 1 extends in the three directions of an orthonormal coordinate system, typically comprising a longitudinal direction L1 of the vehicle 1 between the rear AR1 and the front AV1 of the vehicle 1, a transverse direction T1 of the vehicle 1 between its lateral sides, and a vertical direction V1 in elevation of the vehicle 1 with respect to its rolling plane PR1 on the ground.

This figure illustrates the application conditions in the test workshop of a lateral impact C1 against the underbody of the vehicle 1 formed by the chassis of the vehicle 1. According to a test protocol, a lateral impact C1 is simulated in which the impact is applied by a post 2 against the underbody of the vehicle 1, with a forward speed of the vehicle 1 of 32 km/h (˜20 mph), the vehicle 1 being oriented in its longitudinal direction L1 with an inclination angle A1 of 75° with respect to the direction of the applied lateral impact C1.

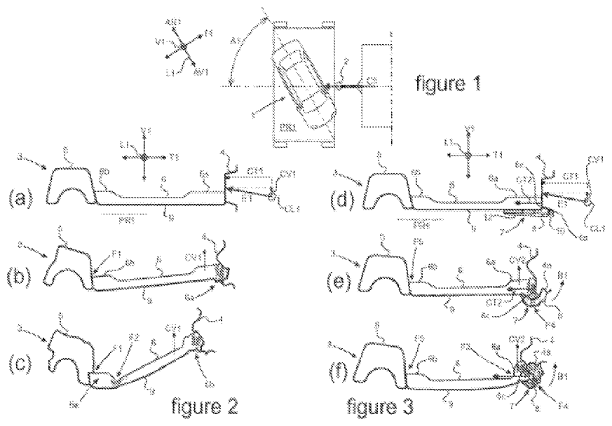

In FIGS. 2 and 3, the chassis 3 of a motor vehicle 1, providing a vehicle underbody, comprises lateral side members 4, only one of them being shown in the context of the lateral impact C1 applied against the vehicle 1 illustrated in FIG. 1. The chassis 3 also comprises a longitudinal frame element 5 which is interposed transversely on the chassis 3 between the lateral side members 4. In the illustrated example, the longitudinal frame element 5 is formed by a tube. A crossmember 6 interconnects the tube 5 and the side member 4. A first end 6a of the crossmember 6 is fixed to the side member 4 and a second end 6b of the crossmember 6 is fixed to the tube 5. The crossmember 6 is, in particular, a seat crossmember supporting at least one seat for the front passengers of the vehicle.

In diagrams (a) and (d), the chassis 3 is subjected to the lateral impact C1 applied against the side member 4 in the junction zone of the side member 4 with the crossmember 6, as illustrated in FIG. 1. The lateral impact C1 then develops a thrust force E1 against the side member 4. As a result of the longitudinal inclination of the vehicle 1 relative to the direction in which the lateral impact C1 is applied, the thrust force E1 mainly generates a transverse force component CT1, but also at least one longitudinal force component CL1, and, potentially also to a lesser extent, a vertical force component CV1.

As illustrated in diagrams (b) and (c) of FIG. 2 relating to the prior art, the thrust force E1 causes a progressive deformation of the crossmember 6. It is observed that the crossmember 6 then undergoes a significant vertical force component CV1 under the effect of its deformation.

More particularly in diagram (b), the first end 6a of the crossmember 6 is initially subjected to compression. As a result of the various force components generated by the thrust force E1, the vertical force component CV1 tends to bend the crossmember 6 at F1 toward the vehicle interior. The bending at F1 occurs essentially at the junction of the second end 6b of the crossmember 6 with the tube 5. The junction of the crossmember 6 to the tube 5 is weakened and the tube 5 is deformed.

In diagram (c), the onset of bending of the crossmember 6 at F1, illustrated in diagram (b), progressively increases the amplitude of the vertical force component CV1, which results in causing a consequent bending of the crossmember 6 at F2, the second end 6b of the crossmember, and consequently a significant deformation of the tube 5. This then results in a risk of the crossmember 6 and/or of the side member 4 intruding toward the passenger compartment of the vehicle 1, to the detriment of passenger safety.

In diagrams (d) to (f) of FIG. 3, the chassis 3 is provided with a part 7 making it possible to control the modalities of transmission of the thrust force E1 against the crossmember 6, and subsequently of its deformation. The part 7 makes it possible to stabilize the application of the thrust force E1 against the crossmember 6 according to a transverse force component CT2. The part 7 makes it possible to control an increase in the amplitude of the transverse force component CT2 applied against the crossmember 6 by the part 7. In other words, the part 7 is a member directing the application against the crossmember 6 of a transverse force component CT2 via the part 7, the amplitude of which is increased compared to the transverse force component CT1 generated by the lateral impact C1 applied against the side member 4.

This makes it possible to stabilize the deformation of the crossmember 6 in compression by forcing bending of the crossmember 6 at its first end 6a as at F3 as illustrated in diagram (f), which makes it possible to increase the amplitude of the transverse force component CT2 applied against the crossmember 6 by the part 7.

According to the illustrated example, the part 7 is formed by a plate 8 installed under the first end 6a of the crossmember 6 and under the side member 4. The part 7 is in particular pressed against a floor 9 which the chassis 3 comprises, and is formed, for example, by a fairing. The floor 9 essentially extends under the underbody of the vehicle 1 to which it is fixed, parallel to the running plane PR1 of the vehicle 1, and is interposed between the part 7 on the one hand and the crossmember 6 and the side member 4 on the other hand.

The plate 8 is more particularly installed successively overlapping under the first end 6a of the crossmember 6 and under the side member 4, antagonistically supported in a transverse manner respectively against a wall 4a of the side member 4 and against the end face 6c of the first end 6a of the crossmember 6.

To this end, the plate 8 comprises a support member 10 which is which extends in the transverse direction T1 and is applied against and interposed between the wall 4a of the side member 4 and the end face 6c of the first end 6a of the crossmember 6. The support member 10 extends in vertical projection from the plane of the plate 8 toward the side member 4. The wall 4a of the side member, against which the support member 10 is applied, is in particular formed by a wing of the side member 4 which extends over the chassis longitudinally L1 and vertically V1. Under the effect of the lateral impact C1 applied against the side member 4, the support member 10 is therefore antagonistically supported in a transverse manner respectively against the end face 6c of the crossmember 6 and against the wall 4a of the side member 4.

In diagram (e), the plate 8 is first subjected to compression and bending on itself at F4 substantially in the transverse T1 middle zone of the plate. The plate 8 tends to tilt vertically, as at B1, around its junction zone with the first end 6a of the crossmember 6 and consequently is folded against the end face 6c of the first end 6a of the crossmember 6. The plate 8 then forms a shell enveloping the first end 6a of the crossmember 6.

The folding of the plate 8 then gives the plate a shell structure partially enveloping the first end 6a of the crossmember 6 as illustrated in diagram (f). This has the effect of containing the deformation of the crossmember 6 at its first end 6a, which is then subjected essentially to compression. The crossmember 6 tends to bend moderately at its second end 6b, as at F5, while maintaining a robust junction with the tube 5. The deformation of the tube is then also contained.

More particularly in diagram (f), the tilt and the folding of the plate 8 at B1 against the first end 6a of the crossmember 6 places the plate 8 transversely T1 applied against the first end 6a of the crossmember 6. The tilting of the plate 8 at B1 promotes the application by the plate 8 against the crossmember 6 of the transverse force component CT2 and a significant vertical force component CV2 causing a bending of the crossmember 6 at its first end 6a, as at F3, and therefore outside the intrusion field of the crossmember 6 toward the passenger compartment of the vehicle 1.

The moderate bending at F5 of the crossmember 6 previously initiated at its second end 6b as illustrated in diagram (e) is then significantly contained. This has the effect of maintaining a robust junction between the crossmember 6 and the tube 5, and thus significantly limiting deformation of the tube 5.

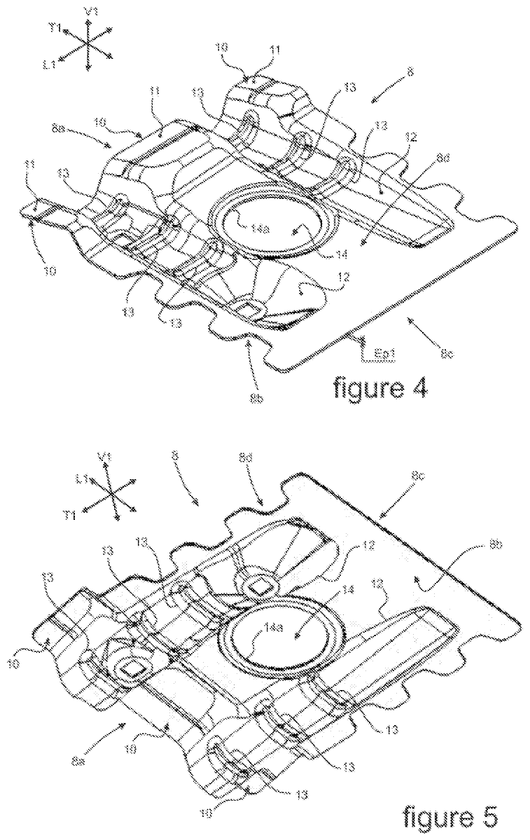

In FIGS. 4 and 5, the orthonormal coordinate system L1, T1, V1 defined above is used to define the directions in which the plate 8 and/or its components extend with respect to the chassis 3, in the installation station of the plate 8 on the chassis 3. The plate 8 comprises the support member 10, which is composed of lugs 11 which are formed at the first junction end 8a of the plate 8 to the side member 4 while being transversely distributed on the plate 8 to which they are integral.

The plate comprises various members 12, 13, 14 for controlling its deformation caused under the effect of the lateral impact C1, including bosses 12 provided with weakening reliefs 13, and a weakening member 14 of the plate 8.

The bosses 12 extend transversely T1 on the chassis, projecting vertically from the lower face 8b of the plate 8 which is intended to be oriented toward the rolling plane PR1 of the vehicle 1. The bosses 12, two of which are shown in the illustrated example, are longitudinally L1 spaced apart from one another and are provided at the border of the edges of the plate 8 oriented transversely T1. The bosses 12 form reinforcements for the plate 8 against a longitudinal force component developed by the lateral impact C1. The configuration of the bosses 12 promotes the shaping of the plate 8 in the shell under the effect of the lateral impact C1, as illustrated in diagrams (e) and (f) of FIG. 3, or in other words a deformation of the plate 8 in compression and bending F4 toward the end face 6c of the first end 6a of the crossmember 6.

The vertical extension V1 of the bosses 12 gradually decreases from the end 8a of the junction of the plate 8 to the side member 4, via the support member 10, toward its transversely T1 opposite end 8c which is applied against the crossmember 6 on its lower face, via the floor 9. The bosses 12 thus have a tapered structure along their transverse extension T1, vertically V1 from the junction end 8a of the plate 8 to the side member 4 toward its the end 8c transversely T1 opposite.

In addition, the bosses 12 comprise weakening reliefs 13 that extend longitudinally L1 while being transversely T1 distributed over the bosses 12. The weakening reliefs 13 are contained inside the volume delimited by the bosses 12, and are formed in vertical projection toward the upper face 8d of the plate 8, via which the plate 8 is applied against the first end 6a of the crossmember 6 and the side member 4 via the floor 9. According to the illustrated example, the weakening reliefs 13 are formed by indentations made on the bosses 12. Other arrangements of the weakening reliefs 13 can be used, such as, for example, grooves made in the wall of the plate 8 from which the bosses 12 originate.

The weakening member 14 of the plate 8 is arranged longitudinally L1 between the bosses 12, in the transverse T1 middle zone of the plate 8. According to the illustrated example, the weakening member 14 is formed by a circular opening 14a which is formed through the thickness Ep1 of the plate 8, perpendicular to the plane thereof, opening out to the lower 8b and upper 8d faces of the plate 8. The weakening member 14 of the plate 8 also promotes, alone or in combination with the weakening reliefs 13 with which the bosses 12 are provided, the shaping of the plate 8 into a shell under the effect of the lateral impact C1, as illustrated in diagrams (e) and (f) of FIG. 3, or in other words the deformation of the plate 8 in compression and in bending F4 as a result of its tilting B1.

1. A chassis of a motor vehicle comprising side members, at least one of said side members being connected to at least one longitudinal frame element via a crossmember, a first end of said crossmember being fixed to one of said side members and a second end of said crossmember being fixed to said longitudinal frame element, and a part jointly attached to the side member and to the crossmember, said part comprising a support member which is transversely interposed on the chassis between a wall of the side member and an end face of the first end of the crossmember, said support member being antagonistically supported in a transverse manner under the effect of a lateral impact applied against the side member.

2. The chassis according to claim 1, wherein said part extends transversely on the chassis and extends, in successive overlap, under the first end of the crossmember and under the side member.

3. The chassis according to claim 1, wherein said part defines a plate which extends at least under the first end of the crossmember and wherein said support member transversely projects from the crossmember between the end face of its first end and said wall of the side member.

4. The chassis according to claim 3, wherein said support member comprises at least one lug integral with the plate and extending in elevation overhanging the plane in which the plate extends.

5. The chassis according to claim 1, wherein said part has, projecting from a lower face thereof, at least one boss extending transversely relative to the chassis, an elevation of said boss gradually decreasing from the support member along the length of the boss transversely relative to the chassis.

6. The chassis according to claim 5, characterized in that the boss comprises at least one recessed relief formed on the underside of said part extending perpendicularly to a main direction of the boss and extending longitudinally of the chassis.

7. The chassis according to claim 4, wherein the plate has an opening extending through a thickness of said plate.

8. The chassis according to claim 1, wherein said part is fixed under a floor fitted to the chassis, the floor being interposed between said part on the one hand and the side member and the first end of the crossmember on the other hand.

9. The chassis according to claim 1, wherein said longitudinal frame element is either a side member or a tube that is transversely interposed on the chassis between the lateral side members.

10. A motor vehicle equipped with the chassis according to claim 1.
